(19) United States
(12) Patent Application Publication
(10) Pub. No.: US 2026/0354295 A1
(43) Pub. Date: Nov. 12, 2026

(54) MOBILE AGRICULTURAL SOIL IMPROVEMENT MACHINE AND METHOD

(71) Applicant: Turnerland Manufacturing (PTY) Ltd, Hopefield (ZA)

(72) Inventor: Francois TURNER, Hopefield (ZA)

(73) Assignee: Turnerland Manufacturing (PTY) Ltd, Hopefield (ZA)

(21) Appl. No.: 19/132,001

(22) PCT Filed: Nov. 22, 2023
(86) PCT No.: PCT/IB2023/061768

§ 371 Date: May 22, 2025

(30) Foreign Application Priority Data
Nov. 22, 2022 (ZA) 2022/12673

(51) Int. Cl. A01B 77/00; A01B 27/00; A01B 43/00

(52) U.S. Cl. CPC A01B 77/00; A01B 27/00; A01B 43/00

(57) ABSTRACT

Soil is improved in a mobile soil improvement machine (10) by lifting soil and stones with a share (24) and conveying it on a screen conveyor (30) extending rearwards and upwards while allowing soil to pass through apertures in the screen conveyor (30) under gravity, discharging stones from a conveyor discharge (42) into a crusher (50), crushing the stones and discharging the crushed stone under gravity.

### FIELD OF THE INVENTION

This invention relates to machines for improving the suitability of soil containing stones for agriculture due to the ever-increasing scarcity of land and the ever-growing population.

### BACKGROUND TO THE INVENTION

No root crop can be grown in stone or rock soil and in order to render land suitable for agriculture, excess stones are typically removed, primarily because stones pose an obstruction to cultivation and cause damage to agricultural equipment. Stones are typically removed from soil by ploughing the stones up and/or removing the stones manually or with mechanical stone pickers as well as ripping and scarifying to work the stone or rock up to the surface. Big boulders are removed with construction equipment e.g. jaw grabs pick up the stones to be loaded into dump trucks. Star or belt type destoners and soil conditioners or landscapers with elevators load stone or rock unto dump trucks to transport them to outside the worked area or field. These are however costly and labour-intensive procedures, and it is often unfeasible to remove stones from agricultural land.

The present invention seeks to provide for the efficient improvement of the suitability of soil containing stones, for agriculture or recreational areas such as golf courses and sports fields.

### SUMMARY OF THE INVENTION

According to a first aspect of the present invention there is provided a mobile soil improvement machine having a front and a rear, referring to an intended direction of travel for the machine, said machine comprising:
a share that extends transversely to the direction of travel;
a conveyor arrangement including at least a first screen conveyor and said conveyor arrangement having a conveyor discharge, said first screen conveyor having a receiving end in close proximity to the share and extending rearwards and upwards from the receiving end, said first screen conveyor defining apertures that are sized to allow soil to pass through the apertures under gravity, but to prevent stones from passing through the apertures; and
a crusher with an inlet and a discharge, said crusher inlet being disposed to receive material from the conveyor discharge.

The term “share”, used in the singular, is intended also to include a share comprising multiple share elements, arranged side-by-side in close proximity, to operate together.

The term “extending”, when used in relation to a conveyor, refers to the direction in which the conveyor is configured to move its load.

The term “screen conveyor” is used herein to refer to any conveyor with apertures or perforations of predetermined size, through which smaller particles can fall, while larger particles are carried on the conveyor, including (without limitation) star conveyors, mesh conveyors, or the like.

The term “soil” is used herein to refer to rock particle sizes that are small enough for crop cultivation or recreational areas whereas the term “stone” is used for rock particles that are of undesirable size for crop cultivation. The size limit to distinguish between soil and stone may vary between different applications of the present invention but are typically of the order of a few millimetres.

The discharge of the crusher is preferably above the first screen conveyor.

The conveyor arrangement may include a second screen conveyor that defines apertures of a size that allows small stones with a size that is smaller than a predetermined maximum stone size, to pass through the apertures, but said apertures being too small to allow stones larger than the predetermined maximum size to pass through the apertures. The second screen conveyor may extend rearwards from below a discharge end of the first screen conveyor and may have a discharge end at the rear of the machine. This forms part of the screening system and is called “repeating”. Fine material falls through while bigger stones gets carried over to be crushed thus forming further fine material.

The conveyor arrangement may include at least one feed conveyor that is disposed to convey small stones from the first screen conveyor to the conveyor discharge. Preferably, the conveyor arrangement includes a first feed conveyor disposed below the second screen conveyor and extending rearwards, a cross feed conveyor that extends transversely from below a discharge end of the first feed conveyor, and a final feed conveyor that extends forwards and upwards from below a discharge end of the cross conveyor to a discharge end of the feed conveyor. Said discharge end of the final feed conveyor may form the conveyor discharge that is disposed to feed material to the crusher inlet.

Any of the conveyors in the conveyor arrangement may comprise multiple parts and in particular, the final feed conveyor may comprise a first part that extends forward, and a second part that extends from below a discharge end of the first part, and that extends obliquely forward.

According to another aspect of the present invention there is provided a method of soil improvement with a machine traveling in a travel direction, said method comprising:
lifting soil and stones with a share that extends transversely to the direction of travel;
lifting the soil and stones that has been lifted by the share, by conveying said soil and stones on a first screen conveyor extending rearwards and upwards;
allowing at least some of the soil to pass through apertures in the first screen conveyor under gravity;
discharging at least some of the stones from a conveyor discharge into an inlet of a crusher;
crushing the stones in the crusher or impactor; and
discharging the crushed stone under gravity.

The crushed stone is preferably discharged onto the first screen conveyor and soil contained in the crushed stone is allowed to pass through the apertures in the first screen conveyor under gravity.

Stone conveyed on the first screen conveyor is preferably discharged onto a second screen conveyor that extends rearwards and small stones are allowed to pass through apertures in the second screen conveyor, while large stones are not allowed to pass through the apertures and are discharged from the second screen conveyor, preferably at the rear of the machine.

The small stones that pass through the apertures in the second screen conveyor are conveyed to the conveyor discharge where they are fed to the inlet of the crusher.

### BRIEF DESCRIPTION OF THE DRAWINGS

For a better understanding of the present invention, and to show how it may be carried effect, the invention will now be described by way of non-limiting example, with reference to the accompanying drawings in which:

FIG. 1 shows an isometric view from the front and right, of a mobile agricultural soil improvement machine according to the present invention;

FIG. 2 shows an isometric view of the machine of FIG. 1, from the rear and left;

FIG. 3 shows a top view of the machine of FIG. 1;

FIG. 4 shows a right-side view of the machine of FIG. 1;

FIG. 5 shows a rear view of the machine of FIG. 1;

FIG. 6 shows a front view of the machine of FIG. 1;

FIG. 7 shows a diagrammatic sectional view of the machine of FIG. 1 in use, taken at VII-VII as shown in FIG. 3; and

FIG. 8 shows a diagrammatic sectional view of the machine of FIG. 1 in use, taken at VIII-VIII as shown in FIG. 3.

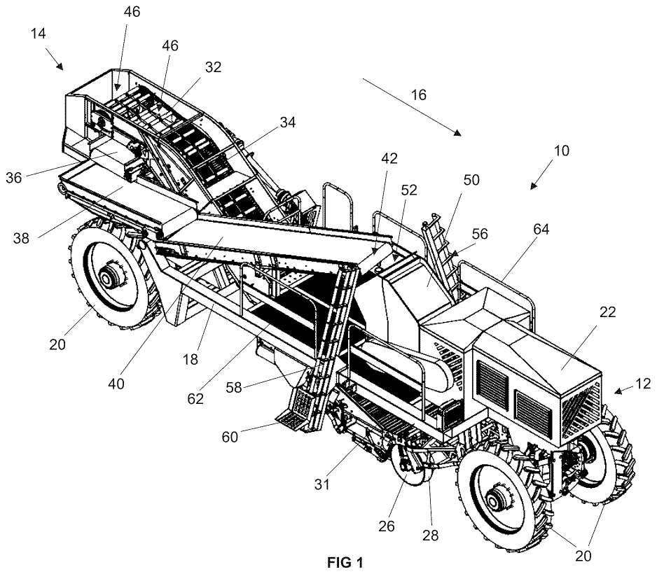

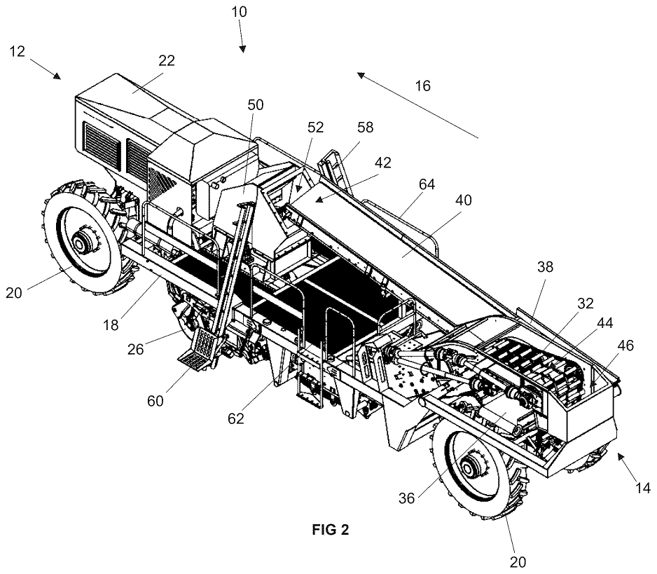

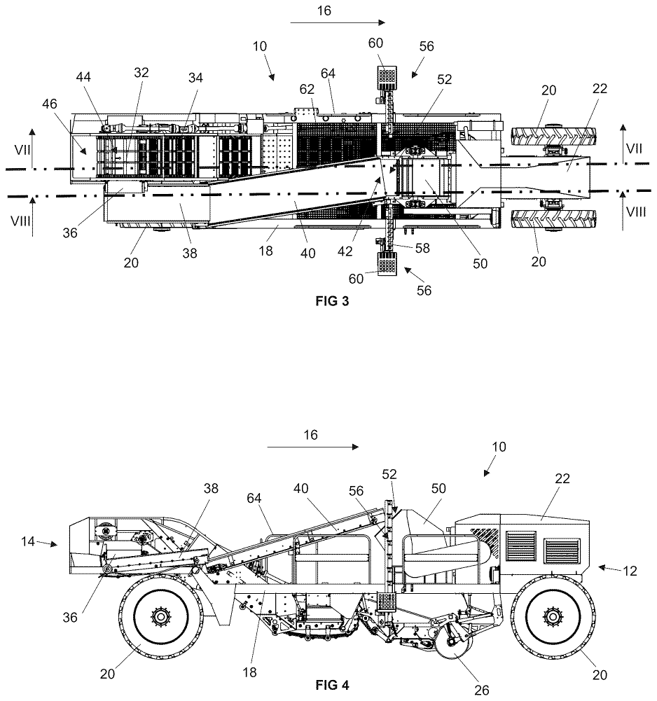

### DETAILED DESCRIPTION OF THE DRAWINGS

Referring to the drawings, a mobile agricultural soil improvement machine according to the present invention is generally identified by reference number 10. The machine 10 has a front 12 and a rear 14 and is intended to travel in a travel direction 16.

The machine 10 includes a chassis 18 that is supported by four ground wheels 20 and the machine is configured to be self-propelled, although in other embodiments of the invention, the machine may be configured to be drawn by a vehicle such as a tractor. The machine 10 can use different sources of motive power for propulsion, but in the preferred embodiment illustrated in the drawings, the machine includes an internal combustion engine that is covered by a cowling 22 and the engine can drive the wheels 20 and/or various other driven components (see below) by mechanical transmission, hydraulically, electrically or the like.

Near the front 12 of the machine 10, a share 24 is provided and extends horizontally, transversely to the travel direction 16 and the share is arranged so that it can be lowered into a field below the machine to cut into the earth and lift soil along with stones that may have been embedded in the soil, as the machine moves forward—in similar fashion as is known in the art of harvesting root crops such as potatoes. At each end of the share 24 there is a lateral cutting disc 26 and roller 28, as are also known in the art of root crop harvesting.

The soil and stones lifted by the share 24 are lifted further and conveyed on the machine 10 in a conveyor arrangement that includes a first screen conveyor 30, a second screen conveyor 32, a first feed conveyor 34, a cross feed conveyor 36 and a final feed conveyor that comprises a first, straight part 38 and a second, angled part 40 that ends at the conveyor discharge 42.

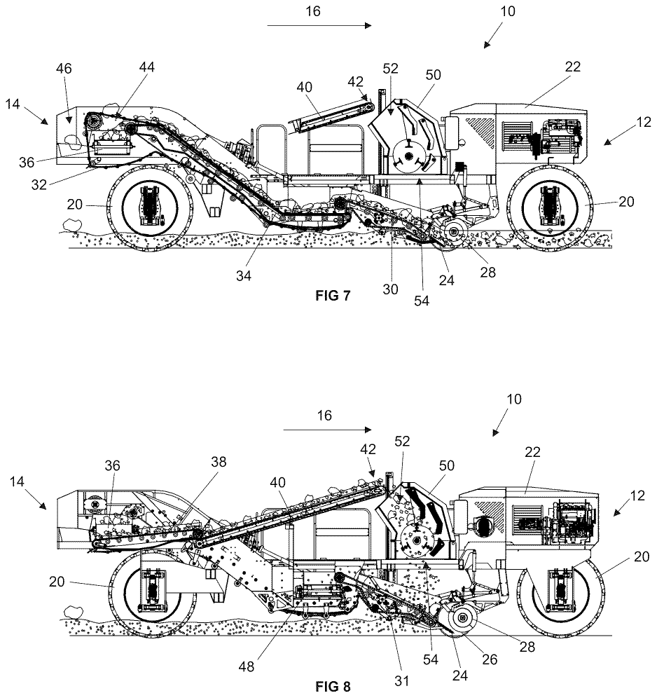

As best shown in FIG. 7, the first screen conveyor 30 has a front end immediately behind the share 24, so that soil and stones lifted by the share is received on the front end of the first screen conveyor.

The first screen conveyor 30 defines apertures that are sized so that soil lifted by the share 24 passes through the apertures under gravity and is returned to the field below the machine 10. In preferred embodiments, the first screen conveyor 30 comprises a digging belt with multiple spaced apart rods that extend across the digging belt, with the apertures defined by the spaces between the rods. The stones are too large to pass through the apertures in the first screen conveyor 30 and are transported rearwards and upwards on the first screen conveyor to rear end of the first screen conveyor. Depending on user preferences, the first screen conveyor 30 can have different sized apertures—with smaller apertures allowing only fine soil to be returned to the field and larger aperture sizes allowing more course soil or some larger rock particles such as course gravel, to be returned to the field.

The second screen conveyor 32 has a front end that is disposed below the rear end of the first screen conveyor 30, so that stones traveling along the first screen conveyor are deposited onto the second screen conveyor. The first feed conveyor 34 is disposed with a top portion of its belt immediately below the second screen conveyor 32, so that the first feed conveyor effectively extends within the closed loop formed by the belt of the second screen conveyor and so that the first feed conveyor and the second screen conveyor together receive the stones from the first screen conveyor.

The first feed conveyor 34 and the second screen conveyor 32 extend horizontally rearwards from below the rear end of the first screen conveyor 30 for a short distance and then extend rearwards and upwards to a rear end of the first feed conveyor. The second screen conveyor 32 is longer than the first feed conveyor 34 so that a rear part 44 of the second screen conveyor does not have the first feed conveyor below it.

Like the first screen conveyor, the second screen conveyor 32 also comprises a belt with multiple spaced apart rods that extend across the belt, with the apertures defined by the spaces between the rods, but the apertures of the second screen conveyor are larger than the apertures of the first screen conveyor 30, so that large stones cannot pass through the apertures of the second screen conveyor and are carried by the second screen conveyor to a discharge end 46 of the second screen conveyor at the rear 14 of the machine 10. Smaller stones are carried by the second screen conveyor 32 and first feed conveyor 34, together, up to the rear end of the first feed conveyor, but at the rear part 44 of the second screen conveyor, the small stones pass through the apertures in the second screen conveyor, under gravity.

The first feed conveyor 34 can comprise a solid belt, but in preferred embodiments of the invention, it is a screen conveyor comprising a belt with multiple spaced apart rods that extend across the belt, with the apertures defined by the spaces between the rods—similar to the first screen conveyor. The small apertures in the first feed conveyor 34 allow soil that may be received from the first screen conveyor 30 onto the first feed conveyor, to pass through the apertures under gravity and to fall to the field below the machine 10.

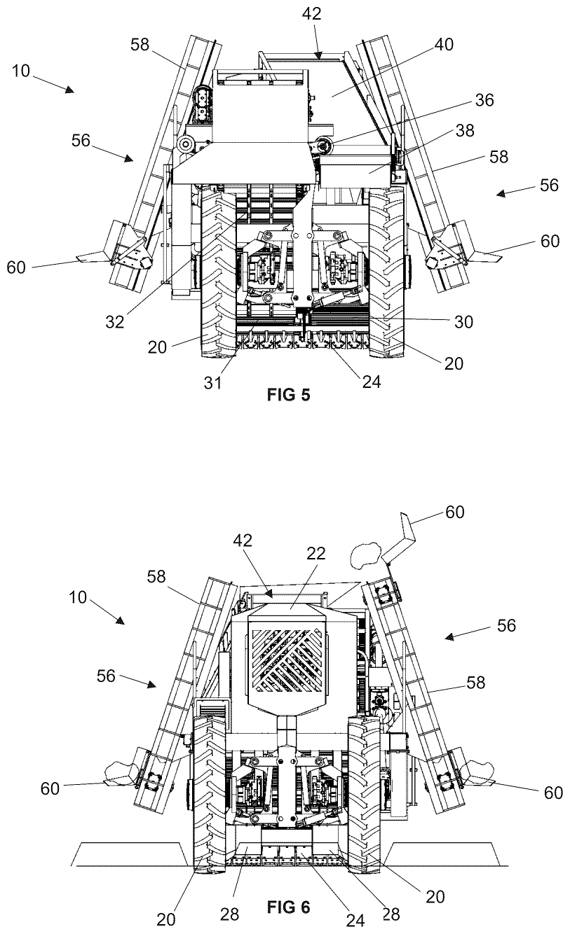

As best seen in FIGS. 5 and 8, the share 24 has a width that is about double the width of the first screen conveyor 30 and the machine includes a screen conveyor that is parallel to the first screen conveyor and is almost identical to the first screen conveyor but is identified in the drawings by reference sign 31. Owing to the identical functions of the first screen conveyor 30 and the parallel screen conveyor 31, reference will be made to both these screen conveyors as “first screen conveyor” but using reference signs 30 and 31 to distinguish between them. First screen conveyor 31 is longer than first screen conveyor 30 and extends rearwards at a steeper incline, so that both first screen conveyors 30 and 31 receive soil and stones from the share 24 and allow soil to pass under gravity through apertures defined in the two first screen conveyors. However, while stones are discharged directly from the rear end of the first screen conveyor 30 onto the second screen conveyor 32 and first feed conveyor 34, stones discharged from first screen conveyor 31 are first discharged onto a cross conveyor 48 (shown only in FIG. 8), that conveys the stones transversely from below the rear end of first screen conveyor 31 to the horizontal part at the front of the second screen conveyor 32 and the first feed conveyor 34.

The purpose of the two parallel first screen conveyors 30 and 31 is to allow the machine 10 to have a wide share 24 that extends the full width between the tracks of wheels 20, so that the entire width of the soil between the tracks of the wheels can be lifted by the share and stones removed. As a result, the machine 10 can treat the soil between the tracks of the wheels 20 in a single pass. However, the width of the second screen conveyor 32 and first feed conveyor 34 can be less than the width of the share 24 and is typically about half the width of the share—i.e. about the same width as each of the first screen conveyors 30,31.

Small stones discharged from the rear end of the first feed conveyor 34 through the rear part 44 of the second screen conveyor 32, are received on the cross-feed conveyor 36, which extends in a transverse direction from below the rear end of the first feed conveyor.

As best seen in FIG. 8, the small stones carried by the cross-feed conveyor 36 are discharged onto a rear end of the straight part 38 of the final feed conveyor, which extends forward in the travel direction 16. The stones are discharged from a front end of the straight part 38 of the final feed conveyor onto a rear end of the angled part 40 of the final feed conveyor, which also extends forward, but is not aligned with the travel direction 16 and instead extends more towards the centre of the machine 10. Each of the straight part 38 and angled part 40 of the final feed conveyor extends forwards and upwards so that the front end of the angled part 40 forms the conveyor discharge 42 that is preferably substantially higher than the first screen conveyors 30 and 31.

The machine 10 includes a crusher 50 with an inlet 52 that is configured to receive stones that are discharged from the conveyor discharge 42 and in the illustrated embodiment, this is achieved under gravity, with the stones simply falling freely from the front end of the final conveyor 40, into the crusher inlet 52 which can be speed controlled by controlling the infeed.

The crusher 50 crushes the stones into smaller particles that are discharged via a crusher discharge 54, onto the first screen conveyors 30 and 31 and in the illustrated embodiment, this is achieved under gravity, with the crushed stones simply falling freely from the crusher discharge onto the first screen conveyors.

Particles of the crushed stone that are discharged from the crusher discharge 54 onto the first screen conveyors 30 and 31 that are small enough, pass through the apertures in the first screen conveyors and fall onto the field below, while particles of the crushed stone that are too large to pass through the apertures in the first screen conveyors, are carried along the first screen conveyors and follow the same route as other small stones, described above, until they are fed to the crusher 50 again. Stones can thus circulate on the machine 10 for multiple passes through the crusher 50 and are only returned to the field once they have been crushed to particle sizes that are small enough to pass through the apertures in the first screen conveyors 30 and 31 The stones that are too large to pass through the apertures in the second screen conveyor 32 and that are discharged at the discharge end 46 of the second screen conveyor, fall under gravity and land on top of the soil in the field, behind the machine 10. These stones can be collected manually and can be removed from the field, but they can also be inspected and if they are deemed suitable to be crushed in the crusher 50, they can be fed to the crusher by lateral feed arrangements 56 on the machine 10.

Each lateral feed arrangement 56 includes an angled track 58 and a support formation such as a scoop 60 that is configured to travel up and down along the track and to pivot at the top of the track, towards the crusher inlet 52. As shown in FIG. 6, large stones can be placed on the scoops 60 when they are in lowered positions near the bottom of each track 58 and the scoops are powered to travel upwards along their tracks and pivot at the tops of the tracks to discharge the stones into the crusher inlet 52.

The machine 10 includes a platform 62 on which operators can stand, e.g. to inspect stones being fed on the angled part 40 of the final feed conveyor, and railings 64 are provided to prevent operators from inadvertently falling off the machine. The machine could also be remote controlled or piloted by an operator in a cab or on the platform.

1. A mobile soil improvement machine having a front and a rear, referring to an intended direction of travel for the machine, said machine comprising:
a share that extends transversely to the direction of travel;
a conveyor arrangement including at least a first screen conveyor and said conveyor arrangement having a conveyor discharge, said first screen conveyor having a receiving end in close proximity to the share and extending rearwards and upwards from the receiving end, said first screen conveyor defining apertures that are sized to allow soil to pass through the apertures under gravity, but to prevent stones from passing through the apertures; and
a crusher with an inlet and a discharge, said crusher inlet being disposed to receive material from the conveyor discharge.

2. The mobile soil improvement machine according to claim 1, wherein the discharge of the crusher is above the first screen conveyor.

3. The mobile soil improvement machine according to claim 1, wherein the conveyor arrangement includes a second screen conveyor that defines apertures of a size that allows small stones with a size that is smaller than a predetermined maximum stone size, to pass through the apertures, said apertures being too small to allow stones larger than the predetermined maximum size to pass through the apertures.

4. The mobile soil improvement machine according to claim 3, wherein the second screen conveyor extends rearwards from below a discharge end of the first screen conveyor and said second screen conveyor has a discharge end.

5. The mobile soil improvement machine according to claim 4, wherein The conveyor arrangement includes at least one feed conveyor that is disposed to convey small stones from the first screen conveyor to the conveyor discharge.

6. The mobile soil improvement machine according to claim 5, wherein the conveyor arrangement includes a first feed conveyor disposed below the second screen conveyor and extending rearwards, a cross feed conveyor that extends transversely from below a discharge end of the first feed conveyor, and a final feed conveyor that extends forwards and upwards from below a discharge end of the cross conveyor to a discharge end of the feed conveyor.

7. The mobile soil improvement machine according to claim 6, wherein said discharge end of the final feed conveyor forms the conveyor discharge that is disposed to feed material to the crusher inlet.

8. The mobile soil improvement machine according to claim 7, wherein the final feed conveyor comprises a first part that extends forward, and a second part that extends from below a discharge end of the first part, and said second part extends obliquely forward.

9. A method of soil improvement with a machine traveling in a travel direction, said method comprising:
lifting soil and stones with a share that extends transversely to the direction of travel;
lifting the soil and stones that has been lifted by the share, by conveying said soil and stones on a first screen conveyor extending rearwards and upwards;
allowing at least some of the soil to pass through apertures in the first screen conveyor under gravity;
discharging at least some of the stones from a conveyor discharge into an inlet of a crusher;
crushing the stones in the crusher; and
discharging the crushed stone under gravity.

10. The method of claim 9, which includes discharging the crushed stone onto the first screen conveyor, and allowing soil contained in the crushed stone to pass through the apertures in the first screen conveyor under gravity.

11. The method of claim 9, which includes discharging stone conveyed on the first screen conveyor onto a second screen conveyor that extends rearwards and allowing small stones to pass through apertures in the second screen conveyor, while large stones are not allowed to pass through the apertures, and discharging said large stones from the second screen conveyor.

12. The method of claim 11, which includes conveying the small stones that pass through the apertures in the second screen conveyor to the conveyor discharge, and feeding said small stones to the inlet of the crusher.
